(19) United States
(12) Patent Application Publication
(10) Pub. No.: US 2016/0233677 A1
(43) Pub. Date: Aug. 11, 2016

(54) AUTONOMOUS VOLTAGE LOAD CONTROLLER

(71) Applicant: DANMARKS TEKNISKE UNIVERSITET, Lyngby (DK)

(72) Inventors: Philip James Douglass, Copenhagen NV (DK); Rodrigo Garcia Valle, Gentofte (DK); Octavian Constantin Tudora, Copenhagen V (DK)

(21) Appl. No.: 15/022,503

(22) PCT Filed: Sep. 18, 2014
(86) PCT No.: PCT/DK2014/050291

§ 371 Date: Mar. 16, 2016

(30) Foreign Application Priority Data
Sep. 18, 2013 (EP) 13184885.5

(51) Int. Cl. H02J 3/14

(52) U.S. Cl. CPC H02J 3/14

(57) ABSTRACT

The present invention relates to a method for controlling a controllable electrical load connected to an electrical distribution system, comprising measuring (401) an electrical voltage signal v in the electrical distribution system, calculating a short term average (402) over a short time period based on the electrical voltage signal and a long term average (403a) over a long time period based on the electrical voltage signal, the long time period being greater than the short time period, and subtracting (406) the short term average from the long term average, said subtraction derives a delta value (407), then multiplying the delta value with a gain factor (420) to get a first desired power consumption, controlling the controllable electrical load according to the first desired power consumption (414). The invention also related to an autonomous voltage load controller.

### FIELD OF THE INVENTION

The present invention relates to a voltage controller and an electrical load connected to an electrical grid.

### BACKGROUND OF THE INVENTION

Distributed generation (DG) connected to power distribution electrical grid is becoming more common as a means to harvest diffuse renewable energy sources (RES). At the same time, in response to the need to reduce emissions and increase supply security, a growing share of the energy system is becoming electrified, increasing the load on the same distribution networks. DG and load growth are expanding the range of operating conditions of distribution systems, and unless large investments are made to upgrade the capacity of the networks, coordinated control of DG and loads will be needed to avoid overloading the systems.

Distribution system operators are required by law to meet power quality standards and avoid overvoltage and undervoltage conditions. European standards for electric power delivery from public networks specify that under normal conditions the 10 minute average RMS voltage level must be 230V±10%. In the USA, voltage standards specify the optimal utilization voltage to be within −10% and +4.3% of nominal.

Maintaining voltage levels within statutory limits will be challenging in existing power distribution systems while distributed generation is added and loads increase.

In regions where photo-voltaic (PV) systems have seen rapid growth, widespread overvoltage problems have already been observed. Existing methods to maximize feasible DG penetration levels in the presence of voltage constraints focus on controlling the active and reactive power output of DGs, but the potential of using controllable loads to mitigate voltage constraints is only beginning to be studied.

Autonomous loads, without digital communication interfaces, have been shown to be capable of providing primary frequency reserves by controlling the loads based on local measurements of system frequency. Using locally measured RMS voltage values as a control input can be considered a continuation of the autonomous load control paradigm.

Time-sensitive and geographically distributed control of today's power system is achieved by the use of local control loops that measure system parameters and act upon them autonomously. Examples include speed droop governors, voltage regulators in synchronous generators, and on-load tap changing transformers.

Generators have primary responsibility for maintaining system frequency and voltage within specified limits with P-f and Q-V droop control. In large power systems with inductive transmission lines, these two control objectives are decoupled, but in the general case (including micro-grids with resistive lines) the two objectives are interrelated.

Local control loops are also being applied to distributed generation (DG) to allow small generation units to coordinate their actions and contribute the stabilizing system frequency and voltage without the overhead of a reliable data communications network. For example, photo-voltaic (PV) inverters connected to low voltage distribution systems in Germany are required to implement P-f droop control to curtail active power when system frequency rises above 50.2 Hz.

An electrical distribution system is understood as the final stage in the delivery of electricity to end users. A distribution system's network carries electricity from the transmission system and delivers it to consumers.

Using loads to regulate system parameters through Under-Frequency Load Shedding (UFLS) and Under-Voltage Load Shedding (UVLS) is well established, but only as a last resort defense.

Hence, an improved and simple system to help controlling voltage and/or frequency in a distributed generation system would be advantageous, and in particular if the control happens not as a last resort defense, but more as an efficient and/or reliable measure in the standard grid control.

### OBJECT OF THE INVENTION

It is thus an object of the invention to provide a control method to help controlling voltage and/or frequency locally in the electrical grid, by controlling selected loads at the consumer side.

While supply-side measures for regulating voltage are widespread, demand-side resources have an untapped potential to contribute the stabilizing voltage in distribution systems

These loads have the potential to modulate their active power consumption and contribute to stabilizing system frequency and voltage as a part of normal operation.

Loads with inherent flexibility, such as thermostat controlled loads (TCLs), can be designed so power consumption is shifted in time without compromising the quality of energy service provided.

Continuing advances in micro-electronics allow sufficiently accurate measurement of system frequency and voltage by the low-cost microcontrollers typically found in white goods appliances. These measurements can provide input to load controllers that allow loads to participate in voltage and/or frequency regulation autonomously without reliance on real-time digital communications. Autonomous load controllers can be deployed in a “fit and forget”-fashion or they may be built with digital communications interfaces to allow remote changes to configuration parameter values.

While autonomous frequency sensitive loads (FSL) have matured to be candidates for mass-deployment, the local consequences of reduced FSL load diversity that unavoidably results from providing frequency regulation service has not been addressed. Specifically, synchronizing loads in response to frequency variations threatens to cause line overload in congested distribution systems. To the extent that these constraints are reflected in RMS voltage deviations, autonomous loads can use RMS voltage as an input to a hybrid controller that dampens the frequency response if and only if line overload occurs.

Controlling loads without digital communication interfaces circumvents the disadvantages introduced by digital communication, namely: cost, reliability, complexity and speed.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Thus, the above described object and several other objects are intended to be obtained in a first aspect of the invention by providing a method for controlling a controllable electrical load connected to an electrical distribution system, comprising:
measuring an electrical voltage signal in the electrical distribution system,
calculating a short term average over a short time period based on the electrical voltage signal,
calculating a long term average over a long time period based on the electrical voltage signal, the long time period being greater than the short time period,
subtracting the short term average from the long term average, said subtraction derives a delta value,
calculating a gain factor based on a variance of the delta value,
multiplying the delta value with the gain factor to get a first desired power consumption,
controlling the controllable electrical load according to the first desired power consumption.

The invention is particularly, but not exclusively, advantageous as the method benefits from coordination with other voltage regulation devices (such as OLTCs) to ensure that lower voltage corresponds to higher aggregated system load and vice versa. For the VSL, the effect of the load controller is to counteract this tendency, i.e. to use less power at low voltage. Deploying the autonomous controller in distribution systems can mitigate the negative effects of high DG penetration and improve utilization of power distribution assets. The use of the short term average, long term average and auto-tuned gain improves the performance of the method.

According to one embodiment of the invention, the short term average and/or long term average are calculated as exponential moving averages or exponential weighted moving averages.

An advantage of this embodiment is that this type of filter i.e. exponential moving averages or exponential weighted moving minimizes data storage requirements, and thus reduces the requirement for computational power.

According to one embodiment of the invention, the method further comprises:
measuring an electrical current measurement following between the electrical distribution system and the controllable electrical load,
calculating a long term average impedance, based on the electrical current measurement and the electrical voltage signal.

An advantage of this embodiment is that it is applicable to all types of loads, not only ON/OFF loads, as the use of the current measurement provides information on the impedance and thus the load can be controlled in a continuous mode.

According to one embodiment of the invention, the method further comprises:
the controlling the load in either an on-mode or an off-mode.

An advantage of this embodiment is that is a very simple way to control the load, and the requirement for the means to turn the load on and off is limited as this can be done by a simple electrical switch depending on the rated current of the load.

According to one embodiment of the invention, the method further comprises:
receiving a load state signal from the controllable electrical load about a load state,
calculating the long term average according to the load state signal.

An advantage of this embodiment is that the typical voltage level is different depending on if the appliance is ON or OFF, therefore finding the long term moving averages of voltage separately for each state, compensates for the changes in the voltage caused by the device itself.

According to one embodiment of the invention, a ratio between the long time period and the short time period is greater than 1000.

An advantage of this embodiment is that the controller can react to rapid changes in voltage allowing it to shift the duty cycle of co-located appliances to be out of phase (the VSL will turn OFF when other appliances turns ON).

According to one embodiment of the invention, a ratio between the long time period and the short time period is greater than 5000.

An advantage of this embodiment is that the controller can help avoid over/under voltage conditions caused by gradual changes in load without reacting to transient (short-duration) changes in load.

According to one embodiment of the invention, the method further comprises:
extracting a frequency signal from the electrical voltage signal,
deriving a difference between the frequency signal and a frequency reference,
multiply the difference with frequency gain constant to get a second desired power consumption,
controlling the controllable electrical load according to the second desired power consumption.

An advantage of this embodiment is that the method can also help controlling the grid frequency.

According to one embodiment of the invention, the method further comprises:
selecting a first and second weighting factor, wherein the sum of the first and the second weighting factor is one,
multiply the first weighting factor with the first desired power consumption and multiply the second weighting factor with the second desired power consumption and add the two multiplication to find a hybrid desired power consumption,
controlling the controllable electrical load according to the hybrid desired power consumption.

An advantage of this embodiment is that the combined voltage and frequency system allow control of both, but in addition the weighting factors can adjust the importance of either parameter: voltage or frequency.

According to one embodiment of the invention, the method further comprises:
a deadband which holds the desired power consumption at zero for the delta value being below a given threshold.

An advantage of this embodiment is that the controlled load does not respond when the system in a safe state, and only responds if the system is in a critical state.

In a second aspect, the present invention relates an electrical autonomous load controller to control a controllable electrical load connected to an electrical distribution system, comprising
a measurement system arranged to measure a voltage of an electrical voltage signal in the electrical distribution system,
a calculator arranged to calculate a short term average over a short time period based on the electrical voltage signal, and a long term average over a long time period based on the electrical voltage signal, the long time period being greater than the short time period,
a calculator arranged to subtract the short term average from the long term average, to derive a delta value,
a calculator arranged to calculate a gain factor based on a variance of the delta value, then to multiply the delta value with the gain factor to get a first desired power consumption,
an output signal arranged to send a desired power consumption signal to a controllable electrical load.

The first and second aspect of the present invention may each be combined with any of the other aspects. These and other aspects of the invention will be apparent from and elucidated with reference to the embodiments described hereinafter.

Many of the attendant features will be more readily appreciated as the same become better understood by reference to the following detailed description considered in connection with the accompanying drawings. The preferred features may be combined as appropriate, as would be apparent to a skilled person, and may be combined with any of the aspects of the invention.

### BRIEF DESCRIPTION OF THE DRAWINGS

FIG. 1 shows a one line system diagram of a controllable load and DG in a radial feeder.

FIG. 2 shows an idealized voltage profile along the length of a feeder.

FIG. 3 shows dependence of thermostat set point on the controller output P_{L} in a heating application with a TCL.

FIG. 4a shows a block diagram of an autonomous load controller with two output states according to the invention.

FIG. 4b shows a block diagram of an autonomous load controller with n-output states according to the invention.

FIG. 5 shows a Frequency Response subsystem.

FIG. 6 shows a block diagram of hybrid frequency and voltage sensitive load controller. Weighting factor alpha is limited to be between [0,1].

FIG. 7 shows dependence of P_{L} on voltage and frequency. The voltage response has a deadband around the expected value v̅, while the frequency response has a continuously linear response.

FIG. 8 shows one line system diagram of a 2-bus test system with voltage-sensitive and conventional loads in a radial feeder.

FIG. 9 shows a one line system diagram of a low voltage radial network with number of voltage-sensitive and conventional loads sharing a common bus through secondary LV transmission lines.

FIG. 10 shows a VSL system with continuous load control with an expected voltage estimator.

FIG. 11 shows the flow diagram for deriving the expected voltage estimator in continuous operation.

FIG. 12 shows time series of power consumption in 2-bus test system for base case and VSL.

FIG. 13 shows time series of power consumption in 2-bus test system showing VSL power and the total system load.

FIG. 14 shows a load duration curve for a 2-bus network for base case and VSL.

FIG. 15 shows a time series of power consumption in LV radial network for base case and VSL.

FIG. 16 shows time series of power consumption in LV radial network showing VSL power, residual load power and the total system load.

FIG. 17 shows a representative time series of hybrid control P_{L} signal and the voltage Pᵥ and frequency P_{f} components.

FIG. 18 shows a time series of aggregate water heater power consumption for base case, FSL and hybrid controller.

FIG. 19 shows average water heater power as a function of system frequency.

### DETAILED DESCRIPTION OF THE INVENTION

The present invention will now be explained in further details. While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

Distribution system operators are required by law to meet power quality standards and avoid overvoltage and undervoltage conditions. Thus as current flows through a transmission line, the magnitude of the voltage drop is given by:

ΔV=I·R·cos(θ)+I·X·sin(θ) (1)

where Θis the power angle and R, X are the resistance and reactance of the transmission line. When V≈1 p.u., eq. (1) can be linearized giving the approximation:

ΔV≈PR+QX (2)

where P, Q are the active and reactive power consumption. FIG. 2 illustrates a typical voltage profile along the length of a radial distribution system. Two cases are shown: The low voltage case when load is high, and DG production low, line 201. The high voltage case with reverse power flow, when production from DG located at the end of the feeder is high, and load low, line 202.

Distribution system transmission lines are predominately resistive (R>X), indicating that active power determines most of the voltage drop. Since the control points provided by conventional loads do not allow control of reactive power separately from active power, the reactive power component will be ignored in this analysis.

The P term in eq. (2) includes DG production P_{DG}, passive uncontrolled loads P_{L,u,} and controllable Voltage Sensitive Loads, VSLs P_{L,vs}:

P=P_{DG}−P_{L,u}−P_{L,vs} (3)

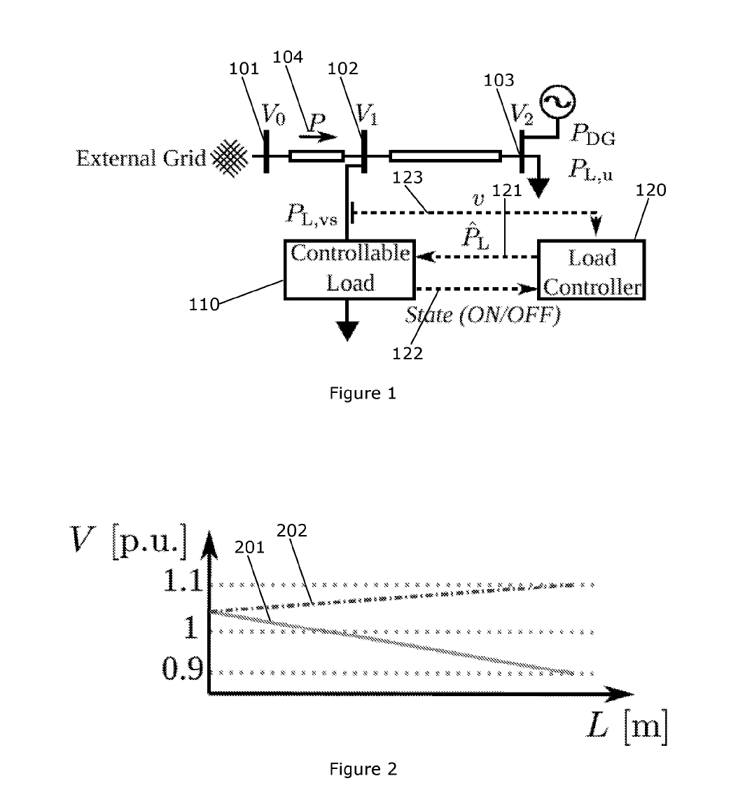

The purpose of the control algorithm analyzed in the description is to modify PL,vs to counteract the fluctuations in P_{DG} and P_{L,u} to reduce the variation of P and V. A simple distribution system with Voltage Sensitive Load (VSL) is shown in FIG. 1. FIG. 1 shows a one line system diagram of a controllable load and DG in a radial feeder where the dashed lines represent control signal paths. The total power drawn from the grid is P 104. The VSL acts to regulate voltage V₁ 102.

FIG. 1 shows an external grid connected to a feeder system with three buses 101, 102, 103. Where the bus 102 has a controllable load 110 connected, the load is controlled by a load controller 120, the load controller has a calculator (not shown) to calculate controller values. The load controller measures a voltage signal 123 at the controllable load 110. The load controller 120 receives at load state signal 122 from the controllable load 110 whether the load is ON or OFF. The load controller 120 sends a desired power consumption 121 to the load 110. The desired power consumption 121 is the setpoint to the load 110.

VSLs may also be co-located with DG to increase the self-consumption of the site. The appliances are assumed to be bi-model, consuming constant power when ON and not consuming power when OFF.

In an embodiment the concept can be extended to appliances with more than 2-discrete states.

In an embodiment the VSLs may be assumed to behave in a more continuous manner.

In operating power systems it is common practice for substations connecting the bulk transmission system to medium voltage (MV) distribution systems to regulate voltage within tight tolerances by the dispatch of reactive power and on-load tap changing (OLTC) transformers. OLTCs are also finding new application in MV/LV transformers. VSLs can co-exist with OLTC and autotransformers only if the regulators are operated to hold voltage within a fixed deadband at their output terminals. If instead, regulators are operated to raise output voltage under high load to target a fixed voltage level at the end of the line, this mode of operation is called “compound regulation” because the position of the tap is a compound function of voltage and current. Some nodes will see the power vs. voltage relationship inverted, invalidating the approximation in eq. (2) and thus the proposed VSL controller cannot be used.

OLTCs can be vulnerable to mechanical wear if fluctuating RES output triggers tap changes, and VSLs can be applied to reduce the short-term fluctuation of load and voltage by shifting some mechanical wear to load actuators.

In low voltage (LV) networks, measures to mitigate voltage fluctuations in real-time are not generally economically feasible and compliance with voltage constraints is ensured during the network design and planning stages. Network planners dimension networks based on the expected peak load and peak DG production. VSLs can be applied to increase the load factor of LV networks because their energy demand is shifted in time to minimize their contribution to peak load.

The present invention shows a method for controlling appliances for voltage based on local measurements of relative deviations of voltage and/or frequency regulation using frequency measures derived from voltage or current measurements.

In an embodiment the method includes an autonomous load control algorithm that contributes to stabilizing system RMS voltage and/or frequency. The performance of this controller is explained by the following description and by simulating its behavior when controlling thermostat controlled loads (TCLs) in a representative distribution system.

The controller produces a signal indicating desired power consumption which can be mapped to temperature setpoint offsets of thermostat controlled loads. The controller finds the relative voltage deviation accounting for the sensitivity of voltage measurements to appliance state. In resistive networks where relative voltage level and system load are negatively correlated, the use of loads for voltage regulation acts to increase the load factor in the network.

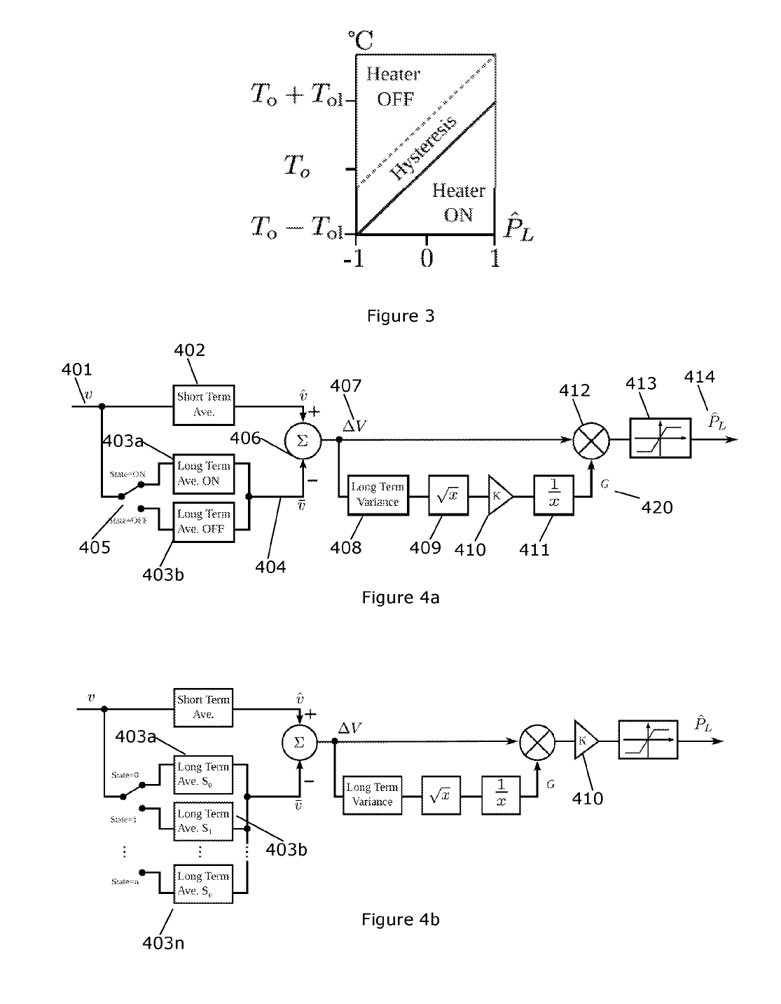

The autonomous load controller operates in the system as shown in FIG. 1. The load controller samples the energy-carrying voltage waveform v, and the state of the load (ON/OFF). The controller output \hat{P}_{L} is the desired load power consumption, normalized to lie between [−1, 1] where −1 represents no power consumption, and 1 represents full power, as shown in FIG. 3, where the user given setpoint (Tₒ) is used when P_{L}=0. FIG. 3 shows the dependence of thermostat setpoint on \hat{P}_{L} in heating application. Y-axis is temperature i.e. of water in hot water tank. The heater turns ON when the temperature falls below the solid line, and turns OFF when the temperature rises above the dashed line. The user given setpoint (Tₒ) is used when P_{L}=0.

FIG. 4b shows an embodiment where the method of control is applied to devices with more states. FIG. 4b differ from FIG. 4a in that the long term average 403 is calculated based on n-different load states, where each load state has its own equation 403a, 403b, . . . 403n. The limitation is that the number of states has to be small so that the device remains in each state long enough to calculate a long-term moving average voltage.

The desired power consumption \hat{P}_{L} is given to a controllable load that will attempt to comply with the request, within the constraints imposed by the final energy conversion process.

FIG. 4a shows a block diagram of the voltage-sensitive load (VSL) controller. The controller is given a RMS voltage measurement 401 and calculates a short-term moving average Vₛₕₒᵣₜ \hat{v} 402 over a time frame of seconds (the exact value is a configurable parameter), a function that filters out measurement noise and transient faults. This short-term average 402 is then subtracted 406 from the long-term average voltage value V_{long} v̅ 404 giving the relative voltage difference ΔV 407. This difference is then scaled by a gain factor G 420 to determine the desired power consumption of the load \hat{P}_{L} 414. The output is limited to be between [−1, 1] in the limiter 413.

It can be summarized as follows:
Take RMS voltage samples at sampling frequency of i.e. 1 second, denoted as v[t] for the voltage measurement at time t.
Calculate the moving average of RMS voltage over a short time period \hat{v}[t] to remove noise. An exponentially weighted moving average, EWMA explained later, with smoothing constant α is used because this type of filter minimizes data storage requirements.

\hat{v}[t]=(1−α)\hat{v}[t−1]+αv[t].
Find the typical voltage level over a long time period v̅[t]. The typical voltage level is different depending on if the appliance is ON or OFF, therefore find the moving averages of voltage separately for each state.

$$∀ v [ t ] , State [ t ] = ON \text{:} \begin{matrix}{\overline{v}}_{on} [ t ] = ( 1 - β ) {\overline{v}}_{on} [ t - 1 ] + β v [ t ] \\ {\overline{v}}_{off} [ t ] = {\overline{v}}_{off} [ t - 1 ]\end{matrix}$$

$$∀ v [ t ] , State [ t ] = OFF \text{:} \begin{matrix}{\overline{v}}_{on} [ t ] {=}_{on} [ t - 1 ] \\ {\overline{v}}_{off} [ t ] = ( 1 - β ) {\overline{v}}_{off} [ t - 1 ] + β v [ t ]\end{matrix}$$

$$\overline{v} [ t ] = \{ \begin{matrix} {\overline{v}}_{on} [ t ] i f state [ t ] = ON \\ {\overline{v}}_{off} [ t ] i f State [ t ] = OFF\end{matrix}$$

The smoothing constant β determines the half-life of the moving average, with 0≦β<<α<1.
Calculate gain G. This is done by finding the long-term moving variance of ΔV[t]=(\hat{v}[t]−v̅[t]).

\hat{σ}²[t]=(1−β)\hat{σ}²[t−1]+β(ΔV[t])²
then, the square root of the variance is found, giving the standard deviation \hat{σ}. This standard deviation is multiplied by a constant K and inverted to give the gain G[t]:

$$G [ t ] = \frac{1}{K \hat{σ} [ t ]}$$

The load control signal is given by:

\hat{P}_{L}[t]=G[t]ΔV[t] (6)
where \hat{P}_{L}[t] is the desired change in power consumption from loads at time t. Finally, \hat{P}_{L}[t] is constrained to lie in the range [−1, 1], limiting the minimum and maximum values.

In an embodiment of the present invention the TCL can be used for demand response, because they represent a large, and potentially controllable, load in residential areas. The thermostat setpoint Tₛ is the result of linearly mapping \hat{P}_{L} to an offset to the user-given thermostat temperature setpoint Tₒ, up (down) to the offset limit Tₒₗ:

Tₛ=Tₒ+Tₒₗ\hat{P}_{L}. (3)

The thermostat state as a function of process temperature and thermostat offset is shown in FIG. 3.

In an embodiment the voltage sensitive loads (VSL) controller is implemented as shown in FIG. 4a.

The purpose of the voltage sensitive loads (VSL) controller is to regulate system voltage by modulating the power consumption of flexible loads. In networks where system load and RMS voltage are inversely correlated, a VSL that reduces power consumption when voltage is low is acting to increase total load diversity.

In an embodiment the long-term average voltage V_{long} v̅ 404 is found by again using a moving average over a time period of hours to days (exact value is configurable, but it must be much greater than short-term value).

In an embodiment the short time period is in the range of seconds to minutes and the long time period is in the range of hours to days.

In an embodiment the difference between the short and long time period is determined as a ratio long time period/short time period, where the ratio is greater than 1000.

In an embodiment the difference between the short and long time period is determined as a ratio long time period/short time period, where the ratio is greater than 5000.

In an embodiment the magnitude of the short time period is considered. A short time constant of less than 10 s (<10 s) allows the VSL to react immediately to changes in other loads.

In another embodiment the short time period is set to be larger (60 s), to avoid under/over-voltage conditions defined by the 10-minute average voltage, and the longer time constant reduced the undesirable situation of the VSL interfering with each other and rapidly switching between being ON and OFF.

In an embodiment two long-term average voltage values 403a and 403b are found: one long-term average of voltage measurements taken when the device is ON 403a, and one when the device is OFF 403b. Switching between the two values based on the state of the device compensates for the changes in voltage caused by the device itself.

The controller “auto-tunes” G 420, thus normalizing the voltage response relative to magnitude of observed voltage variations. The long-term moving variance of ΔV 407 is found over a time span equal to that used for calculating V_{long} v̅ 404. The standard deviation σ is found as the square root 409 of the variance 408, then multiplied by a fixed value K_{V} 410 and inverted 411 to give G 420.

In an embodiment an extension is made to the algorithm described in FIG. 4a, as an addition of a deadband which holds the controller output at zero for values of ΔV below a given threshold.

In the embodiments defining a voltage sensitive load controller, the controller assumed the loads have two or more discrete states of power consumption, and that the loads resided in each state for extended periods of time. This manner of control requires an operational means for the actual control, for the ON/OFF scheme the load can be activated by controlling an electrical controlled switch, known to the skilled person, such as an electromagnetic switch, a solid state switch etc.

In an embodiment the control of the load is performed in a continuous control mode, wherein the actual control is not controlled in an ON/OFF scheme, in a more gradual manner.

In an embodiment the binary ON/OFF algorithm is extending to devices with more than 2 discrete states. An algorithm for more than two discrete states would have a long-term average voltage estimate for each state, and the limitation is that the device must reside in each state long enough to collect enough data to make an accurate estimate of the long-term average (this requirement also applies to a binary device too).

In an embodiment the voltage-sensitive load control algorithm is generalized to accommodate devices with continuously variable power consumption. To accomplish this, the binary input or discrete input to the previous controller “Load State” is replaced by measurements of a load current.

With continuously variable power consumption the operational means for the actual control has to be able accommodate the gradually turning on or off, for a simple load such as a resistive heater this can be achieved by a thyristor based thermostat, in other applications the load may be an electrical motor and here a frequency converter may have to be used in order to implement continuously variable power consumption. The actual invention is not limited to specific operational means.

In a generalization the algorithm that works for devices with variable power consumption is similar to the algorithm for binary ON/OFF devices, except for the calculation of the expected voltage value V_{long}, v̅.

In an embodiment an advanced algorithm is used which needs to the measure the load current I[t]. See FIG. 10, where the long term average 404, of FIG. 4a is exchanged with an expected voltage estimator 1001, the input to the expected voltage estimator is the voltage measurement and a current measurement.

The expected voltage V_{long}, v̅[t] is the no-load expected voltage \hat{v}[t] minus the voltage drop caused by the load current:

v̅[t]=\hat{v}[t]−I[t]\hat{Z}[t].

This voltage drop is estimated by applying Ohm's law to measurements of the load current I[t], and an estimate the upstream Thevenin equivalent impedance \hat{Z}[t].

The state variables \hat{v}[t] and \hat{Z}[t] are found as an exponential moving average as follows:

$$\hat{{Z}^{′}} [ t ] = \frac{\hat{v} [ t - 1 ] - v [ t ]}{I [ t ]}$$

$$\hat{Z} [ t ] = a \hat{Z} [ t - 1 ] + ( 1 - α ) \hat{{Z}^{′}} [ t ]$$

An exponential moving average (EMA), also known as an exponentially weighted moving average (EWMA), is a type of infinite impulse response filter that applies weighting factors which decrease exponentially. The weighting for each older datum point decreases exponentially, never reaching zero.

The impedance is estimated by finding the difference between the previous estimate no-load expected voltage \hat{v}[t−1] and the actual measured voltage v[t] and dividing by the measured current I[t]. Like all measurements in the system, there is considerable noise, so using the law of large numbers; our estimate is the average of many such measurements.

We can only estimate \hat{Z}′[t] when power is being consumed by the load, i.e. I[t]>0.

For the no-load voltage estimate we have:

\hat{v}′[t]=v[t]−I[t]\hat{Z}[t].

\hat{v}[t]=α\hat{v}[t−1]+(1−α)\hat{v}′[t]

Again, the best estimate of \hat{v}[t] is a moving average. The method to derive \hat{v}[t] and \hat{Z}[t] is shown in FIG. 11. The two unknowns: \hat{v}[t] 1111 and \hat{Z}[t]. 1110 depend on each other, ideally there would be periods with no load, so that \hat{v}[t] would converge first, and then form the basis for finding \hat{Z}[t]. This is because of the two long term averages 1101 and 1102, derived as exponential moving average (EMA) or exponentially weighted moving average (EWMA).

FIG. 11 shows the calculation of \hat{Z}′[t] and v̅[t]. The “&”-function 1112 works as a selector depending on the current level. The output of the “&” block should be \hat{Z}′ when I≠0, and when I=0 the output should not be part of the moving average.

The European transmission system operators have considered mandating integration of frequency response into TCLs. Thus there is a need for frequency sensitive loads (FSLs), which are a large, feasible and low cost resource for primary frequency regulation.

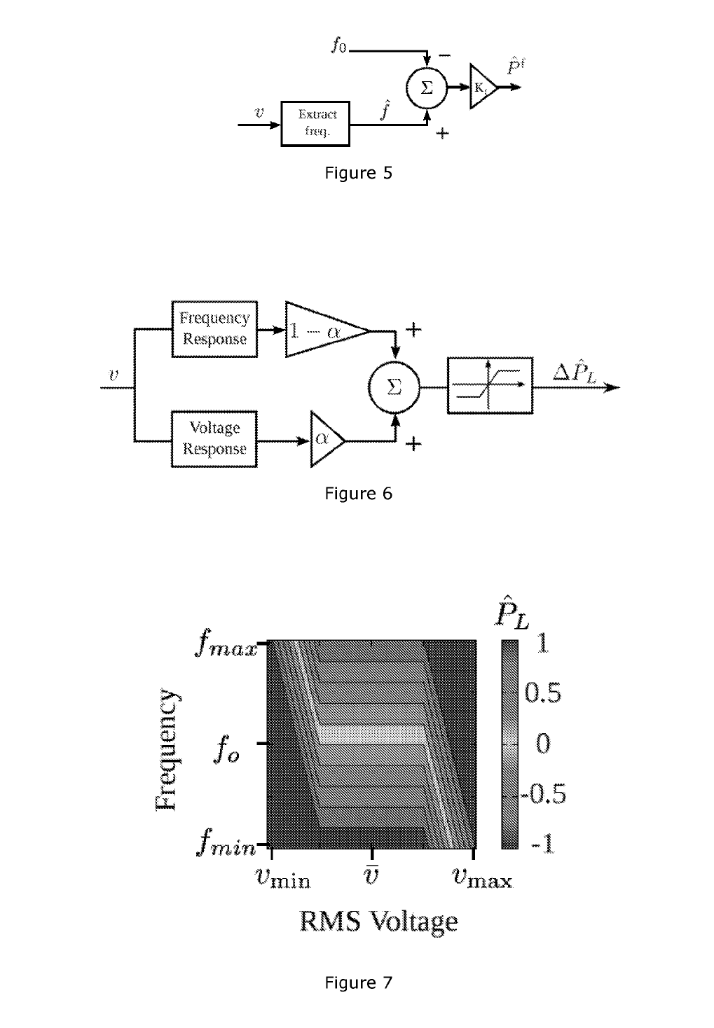

FIG. 5 shows a block diagram of the FSL controller that produces an output frequency \hat{P}^{f} proportional to the AC frequency \hat{f}, the actual AC frequency is extracted from the measured voltage signal v, the difference of the AC frequency \hat{f} and a reference frequency f₀ is derived in a subtraction, the sensitivity of the system is given by the frequency gain constant K_{f} which is multiplied by the difference.

In an embodiment practice of distribution system planners is to assume a random distribution of the internal state of loads and apply a coincidence factor to de-rate the installed capacity of a load class to the maximum expected aggregate load. Field tests of FSL for space heating show that they violate the assumption behind the coincidence factor calculation and in certain weather conditions the aggregate load approaches installed capacity during high frequency events.

A protocol for quickly restoring FSL diversity after a responding to an event has been shown in the prior art, but the protocol does not alleviate the local transmission bottle-necks which arise during the event response itself. A blanket reduction of the capacity of FSLs is suboptimal because congested conditions may happen only in a few locations for a short time.

In an embodiment a Hybrid Frequency-Voltage Sensitive Load controller is applied, wherein both the voltage level and frequency is taken into account when controlling the load.

In an embodiment the FSL controller is implemented as the primary control objective and in another embodiment the FSL controller is implemented together with VSL controller.

The load control algorithm is shown with a high-level block diagram in FIG. 6. For the hybrid solution the output is the weighted sum, with weighting factor α, of a frequency response \hat{P}^{f} and a voltage response \hat{P}^{V}, each of which has been described earlier in this section:

\hat{P}_{L}=(1−α)\hat{P}^{F}+α\hat{P}^{V}

The first weighting factor α and the second weighting factor (1−α) are used to determine the importance of either voltage or frequency control.

The sum of the first weighting factor a and the second weighting factor (1−α) is always one, i.e. unity.

The output \hat{P}_{L} is limited to be between [−1,1]. The optimal value of α will depend on the relative importance of frequency and voltage regulation in a specific power system.

The controller output value is shown graphically as a function of the outputs of two subsystems in FIG. 7, where the parameters of the voltage response are chosen such that there is a deadband (not shown in FIG. 4a) around the long-term average voltage value v̅.

Simulations to show the performance of an embodiment of the invention are conducted on low and medium voltage distribution systems with residential loads including voltage sensitive water heaters. In low voltage systems, the results of the simulations show the controller to be effective at reducing the extremes of voltage and increasing the load factor while respecting end-use temperature constraints. In medium voltage systems the simulation results show the controller to be effective at reducing voltage fluctuations that occur at the 10-minute time scale.

The performance of the proposed load controller algorithm is evaluated with numerical simulations using GridLAB-D on a feeder representing a typical North American distribution system. Grid LAB-D is a discrete event simulation platform that contains detailed models of electrical distribution system components and loads, together with weather data, and a framework for collecting statistics about the state of the network and loads. Unbalanced voltage values are found with high precision because the simulator calculates the full 3×3 mutual impedance matrix for each component.

A network model using typical North American network topologies were created from a survey of operating networks. The network contains a mix of overhead lines, underground cables, unbalanced laterals, 1175 residences, 750 transformers, and a total of 1900 busses. The uncontrolled conventional loads in the system are represented as HVAC loads with a heat load synthesized from typical weather conditions of the Pacific Northwest in January, and ZIP loads (constant impedance, constant current, and constant power) that follow a preset schedule derived from the daily demand patterns observed in the USA. House parameters such as size, indoor temperature preference, and insulation were subject to a uniform distribution.

Distributed generation in the form of PV was added to each house in the distribution system. The sizes of the PV systems were chosen so they produced in aggregate approximately the same amount of energy as the water heaters consumed over the test period. PV production time series were derived from data taken in April from a 7 kW PV system in our lab in Denmark and scaled to the size of each residential system in the simulation, with spacial diversity created by randomly assigning each residence to 6 groups and skewing production profiles by 10 seconds between each group.

System frequency was generated from measurements taken in the Nordic power system as part of a field experiment. Using a pre-recorded frequency time series simplified the simulation by preventing the changes in load from effecting frequency values.

In the simulations the controlled load is modeled as a hot water heater.

Although the load in the example is a hot water heater, the invention is not limited to this type of load.

Model parameters such as water heater power, capacity, thermostat setpoint, thermostat deadband and insulation were subject to a random distribution representing typical values found in such type of equipment in the USA. The water demand of each household was constant at q[t]=57 l/hr representing mean household water consumption, a constant demand assumes a decoupling of the energy demand to heat water and the time of water use. The single phase resistive heating element was modeled as a constant impedance load and the inlet water temperature was fixed to Tᵢₙ[t]=15,5° C. Water temperature in the tank was modeled by a first order discrete equation:

Tw[t+1]=1/C[(To[t]−Tw[t])Uα+w[t]Q+q[t](Tin[t]−Tw[t])]

where the water temperature T_{w} at time t depends on the ambient temperature To, the water temperature at the previous timestep, the thermal conductance of the tank jacket Uₐ, the ON/OFF signal from the thermostat w, the gain of the heating element Q, the water demand q, and the heat capacitance of the full tank C. The temperature of the hot water was modeled as a single body, neglecting the thermocline that arises in real tanks.

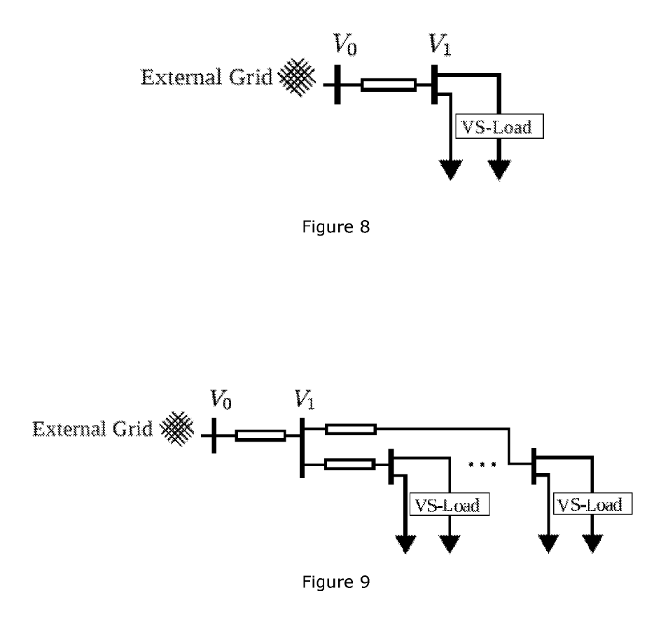

In a 2-Bus scenario the VSL is connected to a common bus (V₁) with conventional loads, shown in FIG. 8. The conventional loads are modeled as a small amount of residential plug and lighting loads which follow a typical diurnal load profile, and a second (conventional) hot water heater with different physical parameters so that the duty cycle and cycle time are different from the VSL water heater. The VSL used a short-term averaging smoothing constant equal to the time step (α=0) to allow immediate response to voltage changes. The long term smoothing constant is set to β=1/10800, the tank had water storage capacity equal to 6.5 hours of consumption.

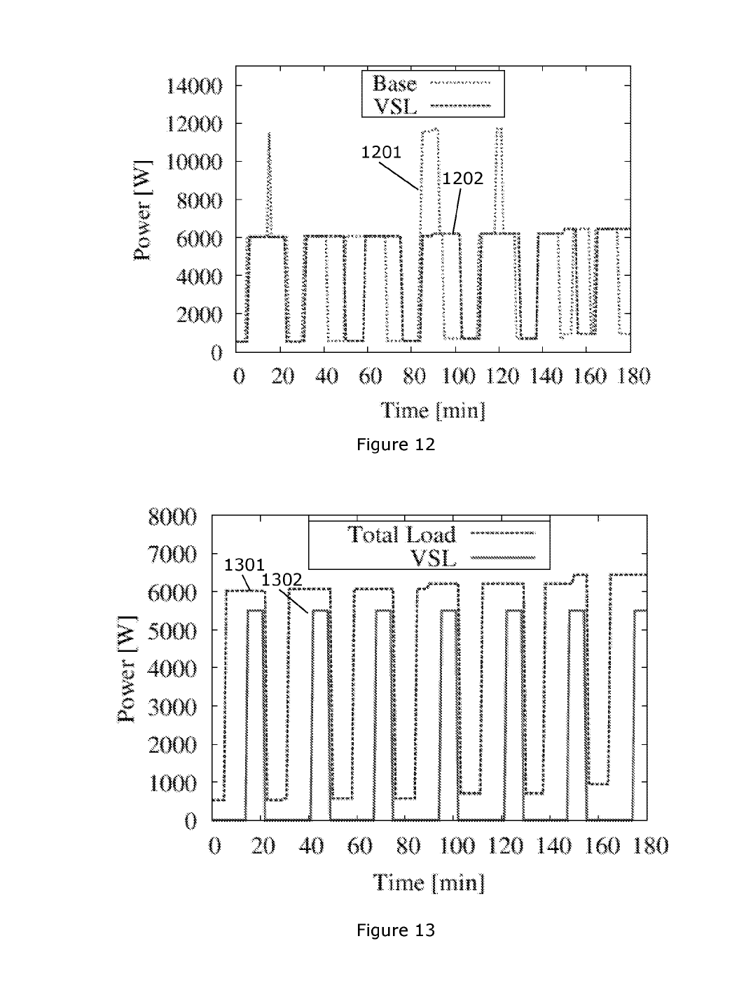

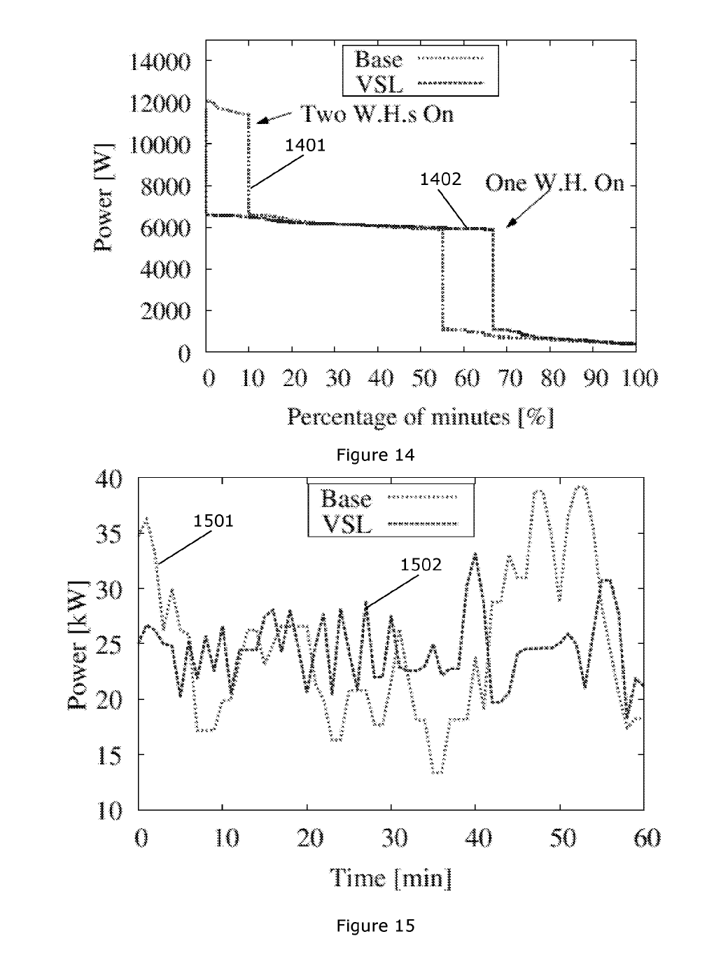

A base case scenario is simulated without the hybrid solution, i.e. combination of VSL and FSL, with an identical setup, except that the VSL controller is disabled. A typical time series comparing power consumption in the base case 1201 and with VSL 1202 is shown in FIG. 12. The relation of the VSL 1302 to the total load 1301 is shown in FIG. 13. The VSL is able to shift its duty cycle to be in anti-phase with that of the large conventional load so that the two are never active simultaneously. This is evident from the load duration curve shown in FIG. 14 with the two traces 1401 and 1402.

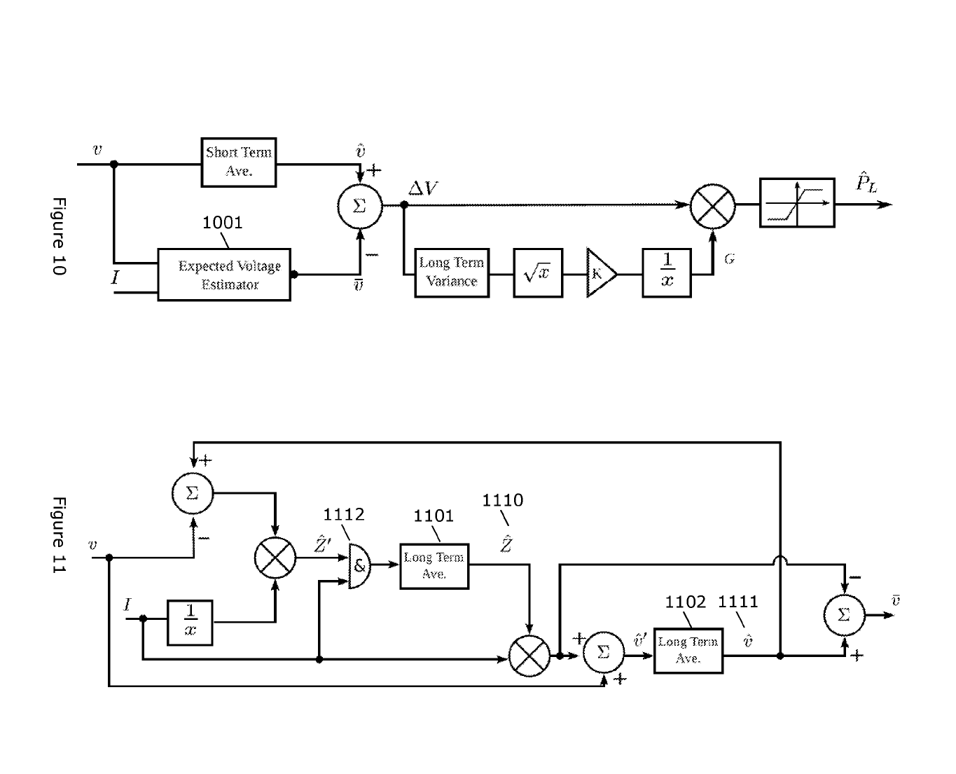

The performance of a group of VSL and conventional loads connected to a common bus (V₁) through LV transmission lines was analyzed in the network shown in FIG. 9. As in the 2-bus scenario, V₀ is held constant, but unlike the 2-bus scenario the impedance of the secondary radials causes each VSL to measure a different voltage. The conventional loads are mainly composed of air conditioning appliances, together with residential plug and lighting loads. The cooling demand is synthesized from the weather data from the pacific northwest of the USA in August. Six VSL water heaters are simulated in a network with 10 houses connected to the network by 240 V split-phase wiring. The VSL used a short-term averaging smoothing constant of a α=1/60 and a long term smoothing constant of β=1/43200. The energy demand for heating water is 13% of the total energy demand of the system. Model parameters such as house size, air conditioning thermostat setpoint, and feeder length were subject to a random distribution representing typical values found in northwestern USA.

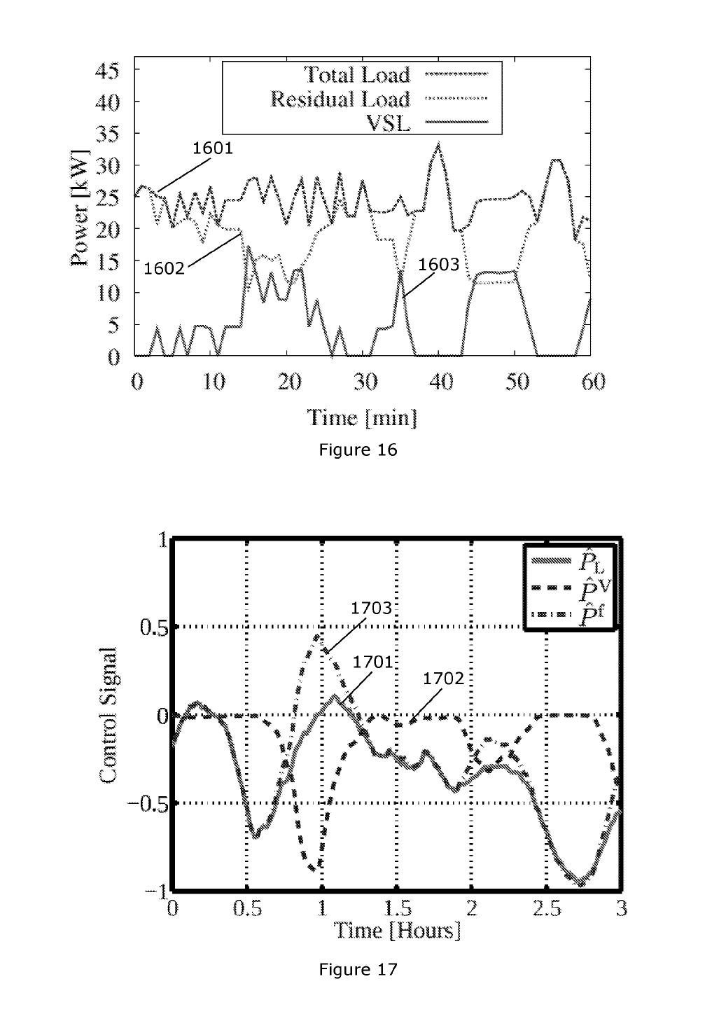

The system was simulated in a base case and with VSL controllers. A representative time series comparing the base case 1501 to VSL 1502 is shown in FIG. 15. A representative time series showing the VSL 1603 as a portion of total loads 1602 is shown in FIG. 16. The load and voltages were characterized by the 10-minute moving average. Performance of the controller with respect to planning criteria was evaluated by finding the 10-minute peak power demand, the contribution of VSL to the peak, load factor, and the correlation coefficient between VSL and residual load. Performance with respect to voltage regulation was evaluated by finding 10-minute phase-to-phase average voltage values, standard deviation of voltage measurements within the 10-minute window, the maximum and the minimum 10-minute voltage values. The performance is summarized in table I.

TABLE I
PERFORMANCE OF VSL IN LV NETWORK

| | | |
|---|---|---|
| Parameter | Base | VSL |

| Peak Power | 40.3 | kW | 34.4 | kW |
|---|---|---|---|---|
| Contribution of VSL to Peak | 18.3 | kW | 6.2 | kW |
| Load Factor | 0.54 | | 0.63 | |
| Corr. Coef. ρVSL, Load | −0.10 | | −0.50 | |
| Mean P-P Voltage | 0.95 | p.u. | 0.95 | p.u. |
| Std. Dev. Voltage (total) | 0.015 | p.u. | 0.012 | p.u. |
| Std. Dev. Voltage (10-min) | 0.013 | p.u. | 0.009 | p.u. |
| Min. 10-min Voltage | 0.89 | p.u. | 0.91 | p.u. |
| Max. 10-min Voltage | 0.98 | p.u. | 0.97 | p.u. |

Compared to the base case, the standard deviation of voltage values is significantly reduced when the VSL is present, though the average voltage is unchanged. The peak power demand is reduced by 15%, and the minimum observed voltage is increased by 2%, a significant improvement considering the total voltage variation tolerance of ±10%.

A large scale model of a typical North American distribution system, modified by increasing the line and the cable resistances is used to represent a more stressed network. This network contained light industrial loads and 1176 houses, each with a voltage sensitive water heater. Residential PV plants injecting power at unity power factor were included at high penetration levels to cause reverse power flows during sunny periods and produce approximately the amount of energy consumed by the VSL. The spacial diversity of the feeder was simulated by randomly distributing PV plants into 6 groups, with production profiles delayed by 10 seconds between each group.

Parameters describing the households size, thermal conductance, thermostat setpoint preferences, etc., were randomly distributed to represent typical values found in North American suburban residential districts. Water heaters accounted for 24% of total energy demand. The smoothing constants were identical to the LV scenario, a α=1/60 and β=1/43200. The load profile followed a diurnal variation, and HVAC demand was synthesized from weather data from the pacific northwest of the USA in January. Ten minute moving averages of the parameters were found, as in the LV scenario. To analyze the effect of VSL on the parameter extremes (max./min.) while considering the variations of PV production and HVAC load, the max./min. value for each parameter was found for each day, and each day was weighted equally in the average daily max./min. value. The VSL is able to follow fluctuations in PV output in all except the shortest transients. Quantitatively, the effects of VSL are summarized in table II.

TABLE II
PERFORMANCE OF VSL IN MV NETWORK WITH PV

| | | |
|---|---|---|
| Parameter | Base | VSL |

| Ave. Daily Max. Load | 3920 | kW | 3880 | kW |
|---|---|---|---|---|
| VSL Load at Max. | 838 | kW | 813 | kW |
| Ave. Daily Min. Load | 142 | kW | 309 | kW |
| VSL Load at Min. Load | 676 | kW | 762 | kW |
| Corr. Coef. ρVSL, Load | 0.01 | | −0.03 | |
| Corr. Coef. ρVSL, PV | −0.30 | | 0.03 | |
| Mean Losses | 99.1 | kW | 97.7 | kW |
| Mean P-P Voltage | 0.997 | p.u. | 0.997 | p.u. |
| Std. Dev. Voltage (total) | 5.88e−4 | p.u. | 5.88e−4 | p.u. |
| Std. Dev. Voltage (10-min) | 4.38e−4 | p.u. | 2.91e−4 | p.u. |
| Ave. Min. Daily Voltage | 0.989 | p.u. | 0.990 | p.u. |
| Ave. Max. Daily Voltage | 1.007 | p.u. | 1.006 | p.u. |

Table II shows that at parameter extremes the most visible effect was on the daily minimum load, where VSL consumption at the minimum load increased by 13%. The size of the thermal energy buffer only allowed relatively short-term load shifting, and the size of the distribution system meant that short-term load diversity was high and there was little scope for improvement. Load peaks were approached gradually, which exceeded the time scale of VSL load shifting, therefore little improvement is seen in this metric and in the voltage extremes. The biggest effect of VSL on voltage levels was the average variation of RMS voltage within 10-minute intervals which was reduced by 34% compared to the base case. The water heaters' power consumption went from being positively correlated with the residual load in the base case, to negatively correlate with residual load when the VSL controller was enabled. The inverse is observed with the correlation between water heater consumption and PV production which went from a negative to positive correlation when the VSL controller was enabled. The presence of VSL lowered average system losses, indicating that less PV power was moved across the distribution system, and more was consumed locally in the residences.

Simulations for an embodiment were run for a base case with static thermostat settings (Tₒₗ=0), scenarios with purely FSLs (α=0), and a balanced hybrid configuration (α=0.5).

In the FSL and hybrid scenarios, the load controllers are configured with a maximum temperature offset of Tₒₗ=3° C. The gain of the purely FSL controller was K_{f}=−30° C./Hz. In the hybrid controller, the frequency gain was increased to K_{f}=−73° C./Hz. The voltage sensitive controller had a short-term average smoothing constant of 1/60 and a long-term average smoothing constant of 1/43200. The deadband was set to one standard deviation s, and the voltage gain KV chosen so the controller saturated when ΔV=2.5σ.

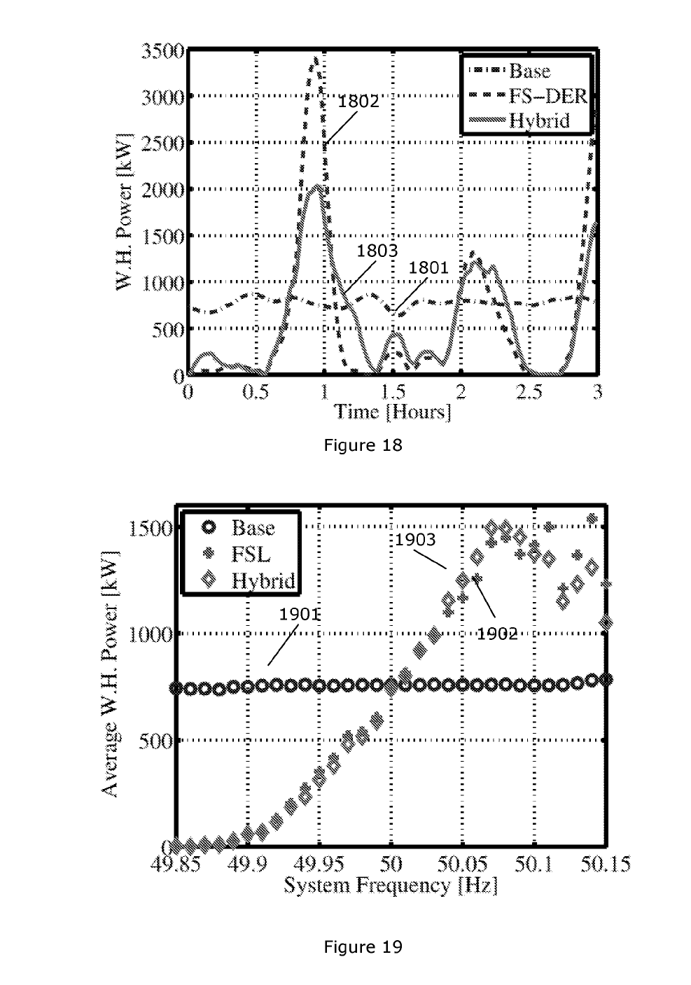

First result shows the frequency response of the water heaters evaluated by grouping each sample of aggregate power consumption by system frequency. The average water heater power as a function of frequency is shown in FIG. 18. The frequency response of the FSL controller matched closely the frequency response of the hybrid controller up until around 50.1 Hz when both controllers saturate.

TABLE III
PERFORMANCE OF BASE CASE,
FSL AND HYBRID CONTROLLER

| Parameter | Base | | FSL | | Hybrid | |
|---|---|---|---|---|---|---|
| Ave. W.H. Power | 757 | kW | 781 | kW | 781 | kW |
| Ave. \hat{ }PL | n.a. | | −0.001 | | −0.008 | |
| Ave. Daily Max. Load | 3925 | kW | 7086 | kW | 6251 | kW |
| W.H. power at Max. | 838 | kW | 4090 | kW | 3409 | kW |
| Mean Losses | 99 | kW | 107 | kW | 105 | kW |
| Ave. Daily Min. V | 0.989 | p.u. | 0.975 | p.u. | 0.979 | p.u. |

Table III summarizes key performance statistics of the system. In both the FSL case and hybrid case, the power consumption of the TCLs increased by 3% compared to the base case, even though the thermostat offset had a slight negative bias. This is because the power consumption of the TCLs is asymmetrical with respect to thermostat offset.

The large amount of FSL greatly worsens the average of the daily peak power consumption measured at the external grid connection from under 4 MW in the base case to over 7 MW. Substituting the FSL with the hybrid controller reduces the peak power to 6.25 MW, an improvement of 12% over the purely frequency sensitive controller, but still significantly worse than the base case. Looking at the power consumption of the water heaters at the daily peak load, the hybrid controller reduced the power of the water heaters at the peak load by 16% compared to the FSL.

The average of daily minimum voltages is lowest with the FSL, improved with the hybrid controller, but best in the base case.

A typical time series showing the frequency response 1703, voltage response 1702, and the combined hybrid response 1701 is shown in FIG. 17. It shows in the first half-hour the voltage response lies in the deadband. Around the one hour mark the voltage response moves in the opposite direction as the frequency response, dampening the frequency response. In the beginning of the second hour, the voltage response has the same sign as the frequency response reenforce the response. The aggregate power consumption of the water heaters is shown in FIG. 18, in the base case, FSL and hybrid controller for the same time period. The hybrid controller has a similar load shape as the FSL but the hybrid controller has clipped the sharp spike in demand at the end of the first hour. The base case shows very little variation in the aggregate water heater power consumption, so it is apparent that any frequency response would worsen the TCL load diversity.

In summary the invention relates to, a method for controlling a controllable electrical load connected to an electrical distribution system, comprising measuring an electrical voltage signal in the electrical distribution system, calculating a short term average over a short time period based on the electrical voltage signal and a long term average over a long time period based on the electrical voltage signal, the long time period being greater than the short time period, and subtracting the short term average from the long term average, said subtraction derives a delta value, then multiplying the delta value with a gain factor to get a first desired power consumption, controlling the controllable electrical load according to the first desired power consumption. The invention also related to an autonomous voltage load controller.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method for controlling a controllable electrical load connected to an electrical distribution system, comprising:
measuring an electrical voltage signal in the electrical distribution system,
calculating a short term average over a short time period based on the electrical voltage signal,
calculating a long term average over a long time period based on the electrical voltage signal, the long time period being greater than the short time period,
subtracting the short term average from the long term average, wherein said subtraction derives a delta value,
calculating a gain factor based on a variance of the delta value,
multiplying the delta value with the gain factor to get a first desired power consumption, and
controlling the controllable electrical load according to the first desired power consumption.

2-12. (canceled)

13. The method for controlling a controllable electrical load according to claim 1, wherein the short term average and/or long term average are calculated as exponential moving averages or exponential weighted moving averages.

14. The method for controlling a controllable electrical load according to claim 1, wherein the method further comprises:
measuring an electrical current measurement following between the electrical distribution system and the controllable electrical load, and
calculating a long term average impedance, based on the electrical current measurement and the electrical voltage signal.

15. The method for controlling a controllable electrical load according to claim 1, wherein the method further comprises:
controlling the load in either an on-mode or an off-mode.

16. The method for controlling a controllable electrical load according to claim 15, wherein the method further comprises:
receiving a load state signal from the controllable electrical load about a load state, and
calculating the long term average according to the load state signal.

17. The method for controlling a controllable electrical load according to claim 1, wherein a ratio between the long time period and the short time period is greater than 1000.

18. The method for controlling a controllable electrical load according to claim 1, wherein a ratio between the long time period and the short time period is greater than 5000.

19. The method according to claim 1, wherein the method further comprises:
extracting a frequency signal from the electrical voltage signal,
deriving a difference between the frequency signal and a frequency reference,
multiplying the difference with frequency gain constant to get a second desired power consumption, and
controlling the controllable electrical load according to the second desired power consumption.

20. The method according to claim 19, wherein the method further comprises:
selecting a first and second weighting factor, wherein the sum of the first and the second weighting factor is one,
multiplying the first weighting factor with the first desired power consumption and multiplying the second weighting factor with the second desired power consumption and adding the two multiplications to find a hybrid desired power consumption, and
controlling the controllable electrical load according to the hybrid desired power consumption.

21. The method according to claim 1, wherein the method further comprises:
providing a deadband, which holds the desired power consumption at zero for the delta value being below a given threshold.

22. An electrical autonomous load controller to control a controllable electrical load connected to an electrical distribution system, comprising:
a measurement system arranged to measure a voltage of an electrical voltage signal in the electrical distribution system,
a calculator arranged to calculate a short term average over a short time period based on the electrical voltage signal, and a long term average over a long time period based on the electrical voltage signal, the long time period being greater than the short time period,
a calculator arranged to subtract the short term average from the long term average, to derive a delta value,
a calculator arranged to calculate a gain factor based on a variance of the delta value, then to multiply the delta value with the gain factor to get a first desired power consumption, and
an output signal arranged to send a desired power consumption signal to a controllable electrical load.

23. The electrical autonomous load controller according to claim 22, wherein the load controlled by the electrical autonomous load controller, is a thermostat controlled load, with an on or an off state.
